(19) United States
(12) Patent Application Publication
(10) Pub. No.: US 2004/0054538 A1
(43) Pub. Date: Mar. 18, 2004

(54) My voice voice agent for use with voice portals and related products

(76) Inventor: Peter Kotsinadelis, Pleasanton, CA (US)

Correspondence Address: Douglas W. Swartz, SHERIDAN ROSS P.C., Suite 1200, 1560 Broadway, Denver, CO, 80202-5141, US

(21) Appl. No.: 10/037,284

(22) Filed: Jan. 3, 2002

(51) Int. Cl. G10L 21/00

(52) U.S. Cl. 704/270

(57) ABSTRACT

The present invention is directed to a voice server 46 comprising a voice agent 62 operable to identify macroinstructions associated with voice commands and execute the macroinstructions and a macrolibrary 66 of macroinstructions and associated voice commands.

### FIELD OF THE INVENTION

The present invention relates generally to automated, interactive, voice responsive systems in telecommunication architectures and specifically to voice portals in telephony networks.

### BACKGROUND OF THE INVENTION

A myriad of digital and analog communications are received each day by users of telephony networks, such as enterprise and private networks. Examples include not only voice messages left by telephone but also electronic mail or e-mail, facsimiles, pagers, and PDA'S. In particular, data networks, such as the Internet, have made it possible for users to obtain e-mail from other network users as well as periodic messages containing information, such as stock quotes, meeting minutes, scheduled meetings, and events, forwarded to a specified network address as e-mail. Additionally, users have personal or business information on the network, such as appointments, contacts, conferencing, and other business information that he or she accesses daily.

Voice portals have been introduced to assist network users in accessing and/or managing the daily influx of digital and analog communications and personal and business information. A voice portal is a voice activated interface that uses pre-programmed voice queries to elicit instructions from users and voice recognition techniques to respond to the instructions. Using voice portals, users can use selected words to access, even remotely, desired types of information. Examples of voice portals include Avaya Speech Access™ sold by Avaya Inc., Speechworks™ sold by Speechworks International, and Tell Me™ sold by Tell Me Networks. In some configurations, voice portals recognize key words or phrases, generate appropriate dual-tone multi-frequency (DTMF also known as Touch-Tone) control signals, and send the DTMF signals to the appropriate server or adjunct processor to access the desired information.

Even though voice portals are fast emerging as a key technology in today's marketplace, little development has been done to streamline their use based on an individual's needs. Voice portals require at least one, and typically multiple, voice commands to access each type or source of information. For example, a user would access e-mail with one set of phrases, voice messages with a second, discrete set of phrases, and appointments calendar with yet a third, discrete set of phrases. The repetitive steps required to access information are clumsy, tedious, and time-consuming, thereby leading to user frustration and lack of utilization of the portal. Many users are also concerned with a potential lack of privacy from using voice portals. If another person can gain access to the voice portal, the person can using well known words and phrases gain access to an individual's records and communications. Typically, only a single layer of protection, namely a password, is employed to provide security of the voice portal.

### SUMMARY OF THE INVENTION

These and other needs are addressed by the various embodiments and configurations of the present invention. The present invention is directed generally to a voice activated macroinstruction which can retrieve automatically (e.g., substantially simultaneously or simultaneously) different types of information and/or information from multiple sources. A macroinstruction or macrostatement or set of macroinstructions or macrostatements(hereinafter “macro”) is an instruction or set of instructions that represents and/or is associated with one or more other instructions. To call up the macro, the macro is assigned a name or associated with one word, multiple words, and/or a phrase (a sequenced ordering of words). Macros permit users to retrieve information using a single spoken voice command compared to conventional voice portals which require multiple sets of words and/or phrases spoken at different times to retrieve different types of information and/or information from different sources.

The macro can be configured or structured in any suitable manner. For example, the macro can be configured as an embedded or compiled (lower tier) command that is specified as a value in a parameter of another (higher tier) command (the macro). As used herein, a “command” refers to one or more instructions, orders, requests, triggers, and/or statements that initiate or otherwise cause a computational component to perform one or more functions, actions, work items, or tasks. The macro can have multiple tiers or levels of embedded voice commands. The various voice commands in the different levels can correspond to additional macro- and/or nonmacroinstructions. A “nonmacroinstruction” is an instruction or a set of instructions that do not qualify as a macroinstruction or set of macroinstructions.

In one embodiment, a voice recognition or voice portal component and voice agent are provided. The voice recognition or voice portal component receives a spoken word or phrase and detects one or more (predetermined) words in the spoken word or phrase. The voice agent receives the detected, (predetermined) words, associates the detected words with one or more macros, and creates, edits, deletes and/or executes the associated macro(s). The voice recognition or voice portal component and voice agent can be in any suitable form, such as software instructions and/or an application specific integrated circuit. In one configuration, a phrase such as “Create agent” is used to initialize the create routine and subsequent phrases are then used to assemble the various embedded macro/nonmacro functions and routines.

The architecture of the present invention can provide a number of advantages. For example, the use of a single word or phrase to retrieve automatically different types of information or information from multiple sources provides a user with faster access and shorter call times. The result is a faster, streamlined, personalized, and user-friendly method for users to access information through a voice portal. The agent can provide additional layer(s) of security of information accessible through the voice portal. The macro(s) created by the user can block access to the information unless the individual seeking access knows the macro name. Multiple layers of macro(s) can be used to provide as many additional layers of protection as a user desires. The user can elect to maintain the macro name(s) private and therefore unaccessible by other users of the network.

These and other advantages will be apparent from the disclosure of the invention(s) contained herein.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 is a block diagram showing a typical hardware implementation of an embodiment of the present invention;

FIG. 2 depicts relational aspects of voice commands according to an embodiment of the present invention;

FIG. 3 depicts relational aspects of voice commands according to another embodiment of the present invention; and

FIG. 4 is a flow chart depicting operation of the voice agent according to an embodiment of the present invention.

### DETAILED DESCRIPTION

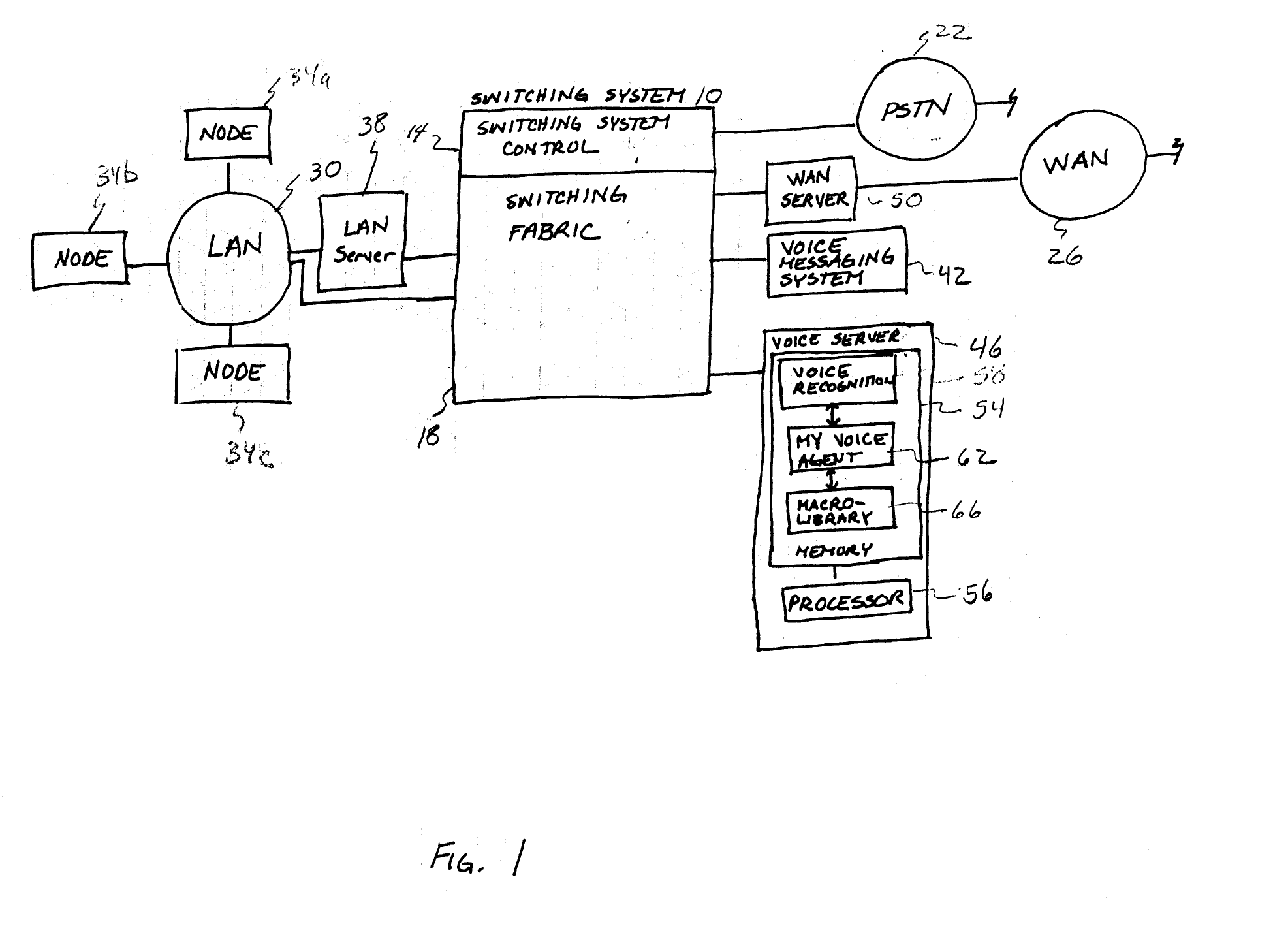

FIG. 1 depicts a hardware implementation of a first embodiment of the present invention. A switching system 10, such as a Private Branch Exchange or PBX, includes both a switching system control 14 for configuring desired connections and a switching fabric 18 for effecting the desired connections. The switching system 10 interconnects the Public Switched Network or PSTN 22, wide area network or WAN 26, local area network or LAN 30 (which further interconnects nodes 34a-c and LAN server 38), voice messaging system 42, and voice server 46. Although the WAN 26 is shown as being distinct from the PSTN 22, it will be appreciated that the two networks can overlap wholly or partially, as is illustrated by the use of the PSTN as part of the Internet.

A number of the components will be known to those skilled in the art. For example, switching system 10 can be an Avaya Inc. Definity® PBX or Prologix®. The PSTN 22 can be twisted wire, coaxial cable, microwave radio, or fiber optic cable connected to telecommunication devices (not shown) such as wireless or wired telephones, computers, facsimile machines, personal digital assistants or PDAs, and modems. WAN 26 can be any network, e.g., a data network, such as the Internet, and provides access to/from the LAN 30 by means of a WAN server 50, such as an Internet Service Provider. LAN 30 can also be any network, as will be known to those skilled in the art, such as an RS-232 link. The network nodes 34a-c can be any one or more telecommunication device(s), including those noted previously. LAN server 38 can be any suitable server architecture, such as Unified Messenger Today® of Avaya Inc. Voice messaging system or VMS 42 is an adjunct processor that receives and stores voice mail messages, such as Audix® VMS of Avaya Inc.

Voice server 46 is typically an adjunct processor that includes both memory 54 and processor 56. Memory 54 of the voice server 46 includes not only known computational components but also a number of components according to the present invention. Voice recognition or voice portal component 58, for example, is any suitable voice recognition and/or voice portal software (and/or ASIC), such as Avaya Speech Access® of Avaya Inc. As will be appreciated, voice recognition component 58 detects selected words by comparing detected voice signal patterns to predetermined voice signal patterns to identify the word in the voice command. Memory 54 further includes my voice agent (or voice agent) 62 which is operable to create or configure voice macros using predetermined words and/or groups of words or phrases and macrolibrary 66 which is operable to store the macros and the associated words and/or groups of words identifying (or used to call) the macros. Processor 56 executes the software instructions associated with the voice recognition software 58 and voice agent 62 and manages macrolibrary 66.

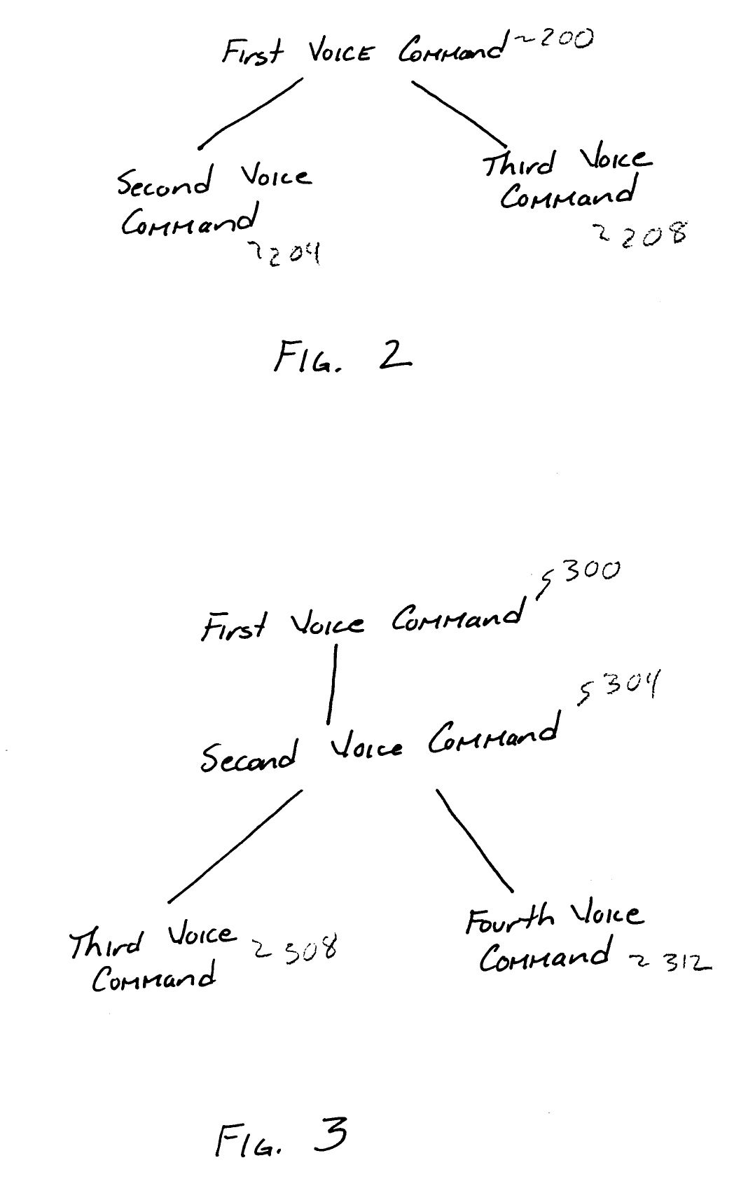

The operation of voice macros is illustrated with reference to FIGS. 2-3.

As shown in FIG. 2 second and third voice commands (having associated word(s) and/or group(s) of words) 204 and 208 are embedded in a first voice command (having an associated word and/or group of words) 200. Thus, a user may by speaking the first voice command 200 cause voice agent 62 to execute automatically the actions associated with the second and third voice commands 204 and 208. The first voice command is thus associated with a macroinstruction to execute instructions associated with the second and third voice commands when the word(s), group of words, or phrase associated with (or naming) the first voice command are detected by voice recognition component 58.

FIG. 3 shows another macro configuration in which voice commands (or macros) are cascaded for additional layers of security. First and second voice commands 300 and 304, respectively, are each associated with macroinstructions while third and fourth voice commands or routines 308 and 312, respectively, are associated with instructions that are not macroinstructions. Thus to execute the instructions associated with the third and fourth voice commands 308 and 312 automatically a user must first speak the first voice command 300 followed by the second voice command 304. If the second voice command 304 is spoken before the first voice command 300, the instructions associated with the third and fourth voice commands 308 and 312 are typically not performed. As will be appreciated, countless other configurations of voice commands are possible, such as using more layers of voice macros and/or at each layer using more or fewer voice macro and nonmacro commands.

An example of the configuration of FIG. 3 is now presented to illustrate more clearly the operation of a voice macro. Assume that the first voice command 300 is the phrase “my day” and the second voice command “my morning”. When a user speaks “my day” and “my morning”, the agent 62 will automatically execute the third voice command 308 “meetings” and the fourth voice command 312 “message” to provide the day's scheduled appointments (associated with the third voice command 308) and the voice messages in VMS 42 (associated with the fourth voice command 312) in accordance with the user's preferences. The user could, in the second layer of voice commands that includes the second voice command 304, place one or more voice (nonmacro) commands such as “e-mail” which would provide the contents of the user's e-mail queue (not shown) in LAN server 38 or node 34 before, during, or after the execution of the third and fourth voice commands 308 and 312.

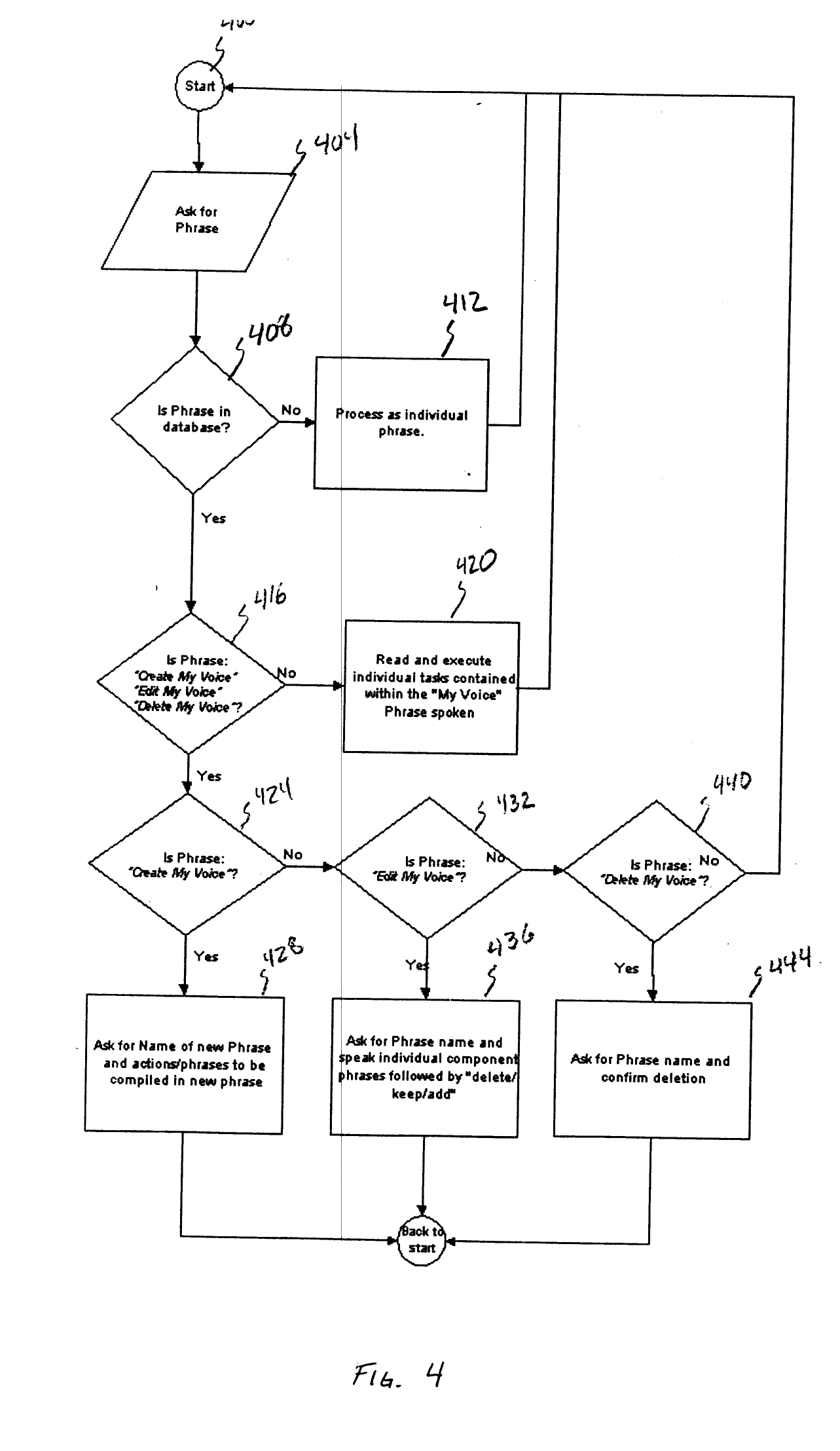

The operation of my voice agent 56 will now be described with reference to FIGS. 1 and 4.

In step 400, the user contacts the voice agent (or agent) 62 by any suitable technique. For example, the user can dial by telephone a specified number or input a network address associated with either voice recognition software 58 or my voice agent 62. A selected series of introductory steps are then performed, which will vary by application. In the case of Avaya Speech Access®, voice recognition software or voice portal 58 first provides to the user the voice message “Welcome to Avaya Speech Access” followed by a request for the user to input a password. When the password is inputted (such as through Touch-Tone or voice) and is confirmed as accurate by the server 46, the agent 62 is activated and performs step 404.

In step 404, the agent 62 requests a spoken phrase or instructions, such as by using the request “How can I help you?”. As will be appreciated, any other expression can be used by the agent 62 to convey to the user that a word or phrase is to spoken to proceed further in the flow chart. This step can be repeated at predetermined time intervals until a word or phrase is detected and recognized or the communication link is terminated by the user. When a spoken word or phrase is received, agent 62 proceeds to step 408.

In step 408, the agent 62 determines whether the spoken word or phrase corresponds to one or more sets of macroinstructions in the macrolibrary 66 by comparing the each spoken word and each possible ordering of spoken words with a table of words and word orderings in the macrolibrary. For each listed word or word orderings in the macrolibrary, there is a corresponding set of macroinstructions which references other nonmacroinstructions and/or macroinstructions. As will be appreciated, words or phrases and associated macroinstructions are typically pre-programmed in the macrolibrary by the manufacturer and additional words or phrases and associated macroinstructions can later be programmed by the user as desired. If the spoken word or phrase is not in the macrolibrary, the agent 62 processes the word or phrase in step 412 as a nonmacro or as an individual word or phrase using techniques known by those skilled in the art. For example, voice portal 58 in step 412 would take over the processing of the word or phrase using known techniques. By first determining if the word or phrase is in the macrolibrary and then determining if the spoken word or phrase is in the general database of the voice portal, the agent 62 prevents system conflicts where a word or phrase references both macro- and nonmacroinstructions. When step 412 is completed, the server 46 returns to step 400. If the spoken word or phrase is in the macrolibrary 408, the agent 62 proceeds to step 416.

The agent 62 in step 416 next determines if the spoken word(s) or phrase is one of “Create my voice?” (which initiates a routine to create a new macro), Edit my voice” (which initiates a routine to edit an existing macro), or “Delete my voice” (which initiates a routine to delete an existing macro). Although not technically macroinstructions, these phrases are pre-programmed into the macrolibrary 66 to permit the user to configure the macrolibrary 66, as desired.

When the spoken word or phrase is not one of the foregoing phrases, the agent proceeds to step 420 and reads and executes the voice commands or instructions referenced in the macroinstruction(s) called by spoken word or phrase. The agent 62 then returns to step 400.

When the spoken word or phrase is one of the foregoing phrases, the agent performs a sequence of queries to ascertain which macroprogramming routine is to be initiated.

Specifically, the agent 62 proceeds to step 424 and determines if the spoken word or phrase is “Create my voice”.

If the spoken word or phrase is “Create my voice”, the agent 62 proceeds to step 428 where the agent 62 first asks for the name of the new macro phrase (or the word(s) or phrase to be used to call up the macro) and then the (typically pre-programmed) associated actions and/or macro and/or nonmacro names that are to be compiled in the new phrase. The agent 62 then returns to step 400.

If the spoken word or phrase is not “Create my voice”, the agent 62 proceeds to step 432 where the agent 62 next determines if the spoken word or phrase is “Edit my voice.”

If the spoken word or phrase is “Edit my voice”, the agent 62 proceeds to step 436 where the agent 62 first asks for the name of the existing macroinstruction to be edited and then for the names of the individual or component macro- and/or nonmacroinstructions followed by the commands “delete” (to remove the component macro- and/or nonmacroinstructions and associated words and phrases from the existing macroinstructions), “keep” (to keep the component macro- and/or nonmacroinstructions and associated words and phrases in the existing macroinstructions), or “add” (to add the individual macro- and/or nonmacroinstructions and associated words and phrases to the existing macroinstructions). The agent 62 then returns to step 400.

If the spoken word or phrase is not “Edit my voice”, the agent 62 next proceeds to step 440 where the agent 62 determines if the spoken word or phrase is “Delete my voice”.

When the spoken word or phrase is “Delete my voice”, the agent 62 proceeds to step 444. In step 444, the agent 62 asks for the name of the macroinstruction to be deleted and then asks for the user to confirm (such as by saying “Yes”) that the macroinstruction is to be deleted from the macrolibrary 66. When step 444 is completed, the agent returns to step 400.

When the spoken word or phrase is not “Delete my voice”, the agent 62 returns to step 400.

A number of variations and modifications of the invention can be used. It would be possible to provide for some features of the invention without providing others.

For example in one alternative embodiment, voice recognition software 58 and/or the agent 62 is/are located on LAN server 38.

In another alternative embodiment, the macros can be created, edited, and/or deleted through a graphical user interface, such as in node 34 and/or LAN server 38. In this configuration, the predetermined word(s) and/or phrase(s) associated with each macro- and nonmacroinstructions are graphically layered or tiered by the user as desired. Alternatively, the user can create, edit, and/or delete macros by audio through a data network such as by using Voice-Over-IP techniques. Typically, it is difficult to record the words or phrases associated with voice macros through a Web site. However, a user can access the voice server through the Web site to perform certain functions, such as assigning macros corresponding titles or names. The words and/or phrases in the title or name can then be recorded through a voice line.

In yet another alternative embodiment, the agent 62 in step 436 provides the user with the words and/or phrases associated with each embedded set of macroinstructions and nonmacroinstructions currently associated with the macroinstruction to be edited. In this manner, the user does not have to keep track of the various instructions referenced in the macroinstruction being edited. The user can then speak the “delete” and “keep” commands with respect to each existing phrase. The user can further say “add” after the existing component macros and nonmacros are reviewed to add additional macros and/or nonmacros to the macroinstruction being edited.

In yet a further alternative embodiment, a further step can be performed after steps 428 and/or 436. In the further step, the user can be queried whether the new macro's associated word(s) or phrase or the new macro's configuration itself is “public” or “private”. If the macro is designated as being “private”, the macro is not provided to or accessible by other nodes 34 of the LAN 30. If the macro is designated as being “public”, the macro is provided to and/or accessible by other nodes 34 of the LAN 30. In other words, other users can graphically view the macroinstructions or hear or view the word and/or phrase associated with the macroinstructions and the various embedded commands in the macro.

In yet a further alternative embodiment, agent 62 can permit the user to create new individual or component (nonmacro) words or phrases and routines associated with the words or phrases. This creation can be performed as part of the operation of the agent rather than the voice portal 58.

In yet a further alternative embodiment, the agent 62 executes the embedded commands in the order in which they are added in step 428. In other words if a first embedded voice command is input before a second embedded voice command, the agent 62 first performs the instructions associated with the first embedded voice command and provides the results to the user and then executes the instructions associated with the second embedded voice command and provides the results to the user.

In yet a further alternative embodiment, the agent 62 will not perform an embedded macro unless the user speaks the macro. This embodiment permits the user to employ additional layers of security. For example, if a second macro is embedded in a first macro and the user speaks the first macro's name the agent 62 will ask the user for the identity or name of the second macro before the second macro is executed.

In yet a further alternative embodiment, a PBX or other switching system is absent. This configuration is particularly useful for a home voice portal. The voice server can be incorporated as part of the telephony network node represented by the residents' various communication devices.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g. for improving performance, achieving ease and or reducing cost of implementation.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for accessing information on a network, comprising:
receiving a first voice command, wherein the first voice command is associated with at least a second voice command and the second voice command is associated with at least one item of work to be performed by a computational component; and
in response to the first voice command, performing the at least one item of work without receiving the second voice command.

2. The method of claim 1, wherein the first voice command is associated with a macroinstruction or set of macroinstructions.

3. The method of claim 1, further comprising:
comparing a third voice command with a macrolibrary to determine whether the first voice command is in the macrolibrary.

4. The method of claim 3, wherein, when the third voice command is not in the macrolibrary, the third voice command is not associated with one or more macroinstructions and further comprising:
performing a work item associated with the third voice command.

5. The method of claim 3, wherein, when the third voice command is in the macrolibrary, further comprising:
determining if the third voice command corresponds to at least one of creating a macroinstruction, editing a macroinstruction, and deleting a macroinstruction;
when the third voice command does not correspond to the at least one of creating a macroinstruction, editing a macroinstruction, and deleting a macroinstruction, executing a macroinstruction associated with the third voice command.

6. The method of claim 5, when the third voice command corresponds to the at least one of creating a macroinstruction, editing a macroinstruction, and deleting a macroinstruction, further comprising:
requesting a name of a macroinstruction.

7. An apparatus that performs the method of claim 1.

8. A computer-readable medium containing software, which, when executed in a computer, causes the computer to perform the method of claim 1.

9. A voice portal of a telecommunications system, comprising:
a macrolibrary containing at least one voice command associated with one or more macroinstructions, the one or more macroinstructions referencing instructions associated with a plurality of voice commands other than the at least one voice command.

10. The voice portal of claim 9, further comprising:
a voice agent operable to (a) receive a voice command from a voice recognition component, the voice command being associated with the one or more macroinstructions in the macrolibrary, (b) associate the voice command with the one or more macroinstructions, and (c) cause the performance of at least one work item associated with the one or more macroinstructions.

11. The voice portal of claim 9, wherein the voice portal is operably connected to a telephony switching system.

12. A voice responsive system for managing information, comprising:
voice recognition means for performing voice recognition on a voice command, the voice command being associated with at least one macroinstruction; and
voice agent means for recognizing, based on at least part of the voice command, the at least one macroinstruction and causing the performance of at least one work item associated with the at least one macroinstruction.

13. The voice responsive system of claim 12, wherein the voice recognition means compares detected voice signal patterns to predetermined voice signal patterns to identify at least word in the voice command.

14. The voice responsive system of claim 12, wherein the voice agent means comprises at least one of creating means for creating a new macroinstruction, editing means for editing a selected macroinstruction, and deleting means for deleting a selected macroinstruction.

15. The voice responsive system of claim 12, further comprising:
memory means for storing the at least one macroinstruction.

16. A voice responsive system for managing information, comprising:
a voice agent operable to receive a voice command from a voice recognition component, at least part of the voice command being associated with at least one macroinstruction, associate the at least part of the voice command with the at least one macroinstruction, and cause the performance of at least one work item associated with the at least one macroinstruction.

17. The voice responsive system of claim 16, wherein the voice agent is connected to a telephony switch.

18. The voice responsive system of claim 16, further comprising:
a macro library containing the at least one macroinstruction and the associated at least part of the voice command.

19. The voice responsive system of claim 16, wherein the voice agent is also operable to create a new macroinstruction, edit a selected macroinstruction, and delete a selected macroinstruction

20. A method for accessing information on a network, comprising:
receiving a first voice command associated with at least a first macroinstruction; and executing the at least first macroinstruction.

21. The method of claim 20, wherein the at least a first macroinstruction references at least a second voice command having a corresponding at least a second instruction and the corresponding at least a second instruction is associated with at least one item of work to be performed by a computational component.
in response to the first voice command, performing the at least one item of work without receiving the second voice instruction.

22. The method of claim 21 further comprising:
comparing the first voice command with a macrolibrary containing a listing of voice commands and corresponding macroinstructions.

23. The method of claim 22, further comprising:
comparing a third voice command with the macrolibrary to determine whether the third voice command is in the macrolibrary.

24. The method of claim 23, wherein, when the third voice command is not in the macrolibrary, the third voice command does not have a corresponding macroinstruction and further comprising:
executing at least one work item associated with the third voice command.

25. The method of claim 23, wherein, when the third voice command is in the macrolibrary, further comprising:
determining if the third voice command corresponds to at least one of creating a macroinstruction, editing a macroinstruction, and deleting a macroinstruction;
when the third voice command does not correspond to the at least one of creating a macroinstruction, editing a macroinstruction, and deleting a macroinstruction, executing at least a third macroinstruction associated with the third voice command.

26. The method of claim 25, when the third voice command corresponds to the at least one of creating a macroinstruction, editing a macroinstruction, and deleting a macroinstruction, further comprising:
requesting a name of at least a fourth macroinstruction.

27. An apparatus that performs the method of claim 20.

28. A computer-readable medium containing software, which, when executed in a computer, causes the computer to perform the method of claim 20.

29. A method for creating a voice macroinstruction, comprising:
receiving at least one spoken word associated with creating a voice macroinstruction;
requesting a voice command corresponding to the voice macroinstruction; and
requesting a plurality of work items to be performed in response to the voice macroinstruction.

30. The method of claim 29, further comprising:
comparing a voice signal associated with the at least one spoken word with a predetermined voice signal to detect the at least one spoken word.

31. The method of claim 29, wherein, when the voice command is detected, the voice macroinstruction is to be executed.

32. The method of claim 29, wherein the plurality of work items are associated with at least a second voice command.

33. An apparatus operable to perform the method of claim 29.

34. A method for editing a voice macroinstruction, comprising:
receiving from a user at least one spoken word associated with editing a first voice macroinstruction;
requesting of the user a first voice command corresponding to the first voice macroinstruction;
presenting to the user at least second and third voice commands embedded in the first voice command; and
receiving from the user, for each of the at least second and third voice commands, an edit command.

35. The method of claim 34, further comprising:
comparing a voice signal associated with the at least one spoken word with a predetermined voice signal to detect the at least one spoken word.

36. The method of claim 34, wherein, when the first voice command is detected, the first voice macroinstruction is to be executed.

37. An apparatus operable to perform the method of claim 34.
